(19) United States
(12) Patent Application Publication
(10) Pub. No.: US 2012/0192814 A1
(43) Pub. Date: Aug. 2, 2012

(54) METAL FUEL POWERED DRIVING SYSTEM AND METHOD OF DRIVING A PISTON IN A CYLINDER

(76) Inventors: Jien-Wei YEH, Hsinchu (TW); Kuang-Chien Hsieh, Hsinchu (TW)

(21) Appl. No.: 13/301,304

(22) Filed: Nov. 21, 2011

(30) Foreign Application Priority Data
Jan. 31, 2011 (TW) 100103707

(51) Int. Cl. F02B 45/08

(52) U.S. Cl. 123/23

(57) ABSTRACT

A metal fuel powered driving system comprises: a cylinder; a piston disposed movably in and cooperating with the cylinder to define a combustion chamber; an arc generating unit including first and second electrodes extending into the combustion chamber, the first electrode being in the form of a first active metal wire; and a first wire supplying unit configured to feed the first active metal wire into the combustion chamber. When the power supplying source applies a voltage to the first and second electrodes, electric arc is generated between the first active metal wire and the second electrode to vaporize and combust the metal wire for driving movements of the piston. A method of driving a piston in a cylinder is also disclosed.

### CROSS REFERENCE TO RELATED APPLICATION

This application claims priority of Taiwanese Application No. 100103707 filed on Jan. 31, 2011.

### BACKGROUND OF THE INVENTION

1. Field of the Invention

The invention relates to a metal fuel powered driving system and a method of driving a piston in a cylinder, particularly to a metal fuel powered driving system and a method utilizing heat of exothermal oxidation of an active metal to drive a piston in a cylinder.

2. Description of the Related Art

For the past few decades, the global surface temperature has been considerably increased. Hence, reducing global warming has become an important issue for every country.

Conventional piston-type engines have been utilizing hydrocarbon liquid fuels to generate mechanical power for applications, such as electric power generator and vehicles. However, burning of the hydrocarbon liquid fuels generates a tremendous amount of carbon dioxide that leads to global warming. Hence, several alternative fuels, such as hydrogen, solid fuels and solar energy, have been studied for application in the piston-type engines.

Metal-containing solid fuels have been used for rockets or missiles in the aerospace industry. Solid fuels normally use aluminum as a component due to its low cost and high exothermal oxidation heat.

U.S. Pat. No. 3,771,313 discloses a method or a power system of generating a motive power. The method includes preheating an active metal-containing liquid fuel to a temperature near the melting point of the active metal, heating a reaction chamber to a temperature sufficient to cause exothermal oxidation of the active metal, and spraying the liquid fuel and a high temperature steam into the reaction chamber using a fuel spray nozzle an a steam spray nozzle, respectively, so as to cause the exothermal oxidation of the active metal and to generate a large amount of a high pressure steam as a source to be transformed into mechanical power.

U.S. Patent Publication No. 2007/0056210 discloses a solid fuel power system that includes a cylinder provided with intake and exhaust valves thereon, a piston disposed movably in the cylinder, a fuel spray nozzle provided on the cylinder for spraying melted aluminum or powdered aluminum into a combustion chamber in the cylinder, and a water spray nozzle provided on the cylinder for spraying water vapor into the combustion chamber. The melted aluminum reacts with the water vapor to generate exothermal oxidation heat, which results in generation of steam as a source of mechanical power.

The aforesaid power systems for generating a motive power or driving a piston are disadvantageous in that they require the use of complicate metal powder feeding means to feed the metal powder into the combustion chamber and the use of heater for heating the combustion chamber and melting the aluminum pellets or powder, which results in an increase in the cost of the power systems.

### SUMMARY OF THE INVENTION

Therefore, an object of the present invention is to provide a metal fuel powered driving system that can overcome the aforesaid drawbacks associated with the prior art.

Another object of the present invention is to provide a method of driving a piston in a cylinder by utilizing the metal fuel powered driving system.

According to one aspect of the present invention, there is provided a metal fuel powered driving system that comprises: a cylinder having a cylinder body and intake and exhaust valves provided on the cylinder body; a piston disposed movably in the cylinder body and cooperating with the cylinder body to define a combustion chamber therebetween; an arc generating unit including first and second electrodes extending into the combustion chamber, the first electrode being in the form of a first active metal wire; and a first wire supplying unit configured to feed the first active metal wire into the combustion chamber. The first active metal wire has an end portion disposed adjacent to the second electrode in the combustion chamber and operatively associated with the second electrode to generate an electric arc therebetween when a voltage is applied to the first and second electrodes, thereby resulting in vaporization of the end portion of the first active metal wire and generation of heat by exothermal oxidation of the metal vapor thus formed.

According to another aspect of the present invention, there is provided a method of driving a piston in a cylinder. The method comprises: supplying a first active metal wire as a first electrode into a combustion chamber of a cylinder; providing a second electrode that extends into the combustion chamber; introducing air into the combustion chamber; and applying a voltage to the first and second electrodes to generate an arc between an end portion of the first active metal wire and the second electrode so as to vaporize the end portion of the first active metal wire and to start exothermal oxidation of the metal vapor thus formed, thereby resulting in generation of thermal energy to drive movement of the piston in the cylinder.

### BRIEF DESCRIPTION OF THE DRAWINGS

In drawings which illustrate embodiments of the invention,

FIG. 1 is a schematic view of the first preferred embodiment of a metal fuel powered driving system according to the present invention;

FIG. 2 is a schematic view of the second preferred embodiment of a metal fuel powered driving system according to the present invention;

FIG. 3 is a schematic view of the third preferred embodiment of a metal fuel powered driving system according to the present invention;

FIG. 4 is a schematic view of the fourth preferred embodiment of a metal fuel powered driving system according to the present invention;

FIG. 5 is a schematic view of the fifth preferred embodiment of a metal fuel powered driving system according to the present invention;

FIG. 6 is a schematic view of the sixth preferred embodiment of a metal fuel powered driving system according to the present invention;

FIG. 7 is a schematic view of the seventh preferred embodiment of a metal fuel powered driving system according to the present invention;

FIG. 8 is a schematic view of the eighth preferred embodiment of a metal fuel powered driving system according to the present invention;

FIG. 9 is a schematic view of the ninth preferred embodiment of a metal fuel powered driving system according to the present invention; and

FIG. 10 is a flow chart of the preferred embodiment of a method of driving a piston in a cylinder according to the present invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

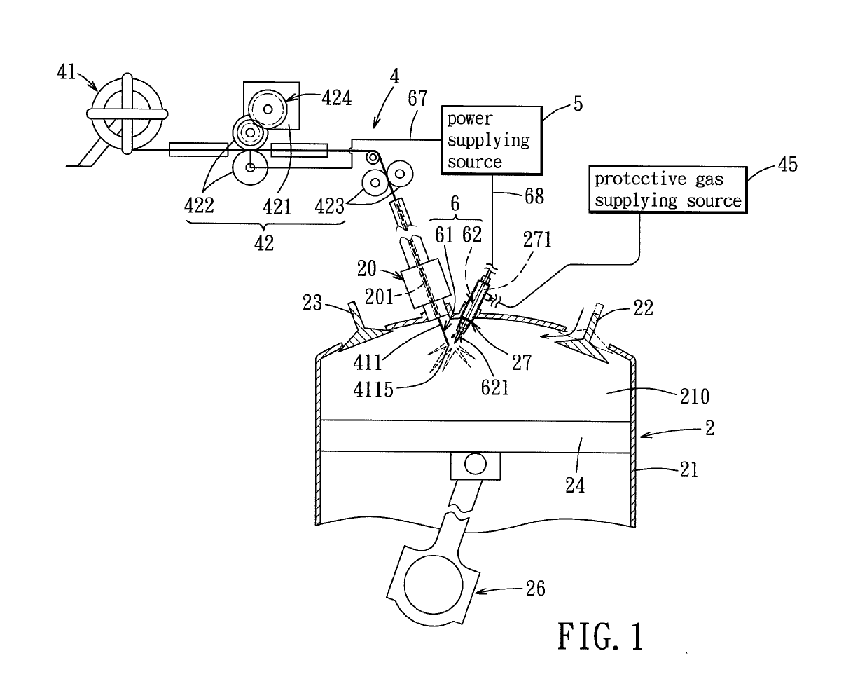

FIG. 1 illustrates the first preferred embodiment of a metal fuel powered driving system according to the present invention. The metal fuel powered driving system can be a single-cylinder engine or a multiple-cylinder engine.

In this embodiment, the metal fuel powered driving system is a single-cylinder engine and includes a cylinder 2, a piston 24 connected with a connecting rod 26, a power supplying source 5, an arc generating unit 6, a first wire supplying unit 4, and a protective gas supplying source 45.

The cylinder 2 has a cylinder body 21, an electrode-mounting sleeve 27 provided on the cylinder body 21, a wire guiding sleeve 20 made from an insulator and provided on the cylinder body 21, and intake and exhaust valves 22, 23 provided on the cylinder body 21. The piston 24 is disposed movably in the cylinder body 21 and cooperates with the cylinder body 21 to define a combustion chamber 210 therebetween. The electrode-mounting sleeve 27 defines a channel 271 therein and extends through the cylinder body 21 into the combustion chamber 210. The intake valve 22 is operable to open so as to permit air to be introduced into the combustion chamber 210 during an intake stroke. The exhaust valve 23 is operable to open so as to permit the exhaust gases formed in the combustion chamber 210 to be discharged during an exhaust stroke.

The arc generating unit 6 includes first and second electrodes 61, 62 extending into the combustion chamber 210. The power supplying source 5 is connected electrically to the first and second electrodes 61, 62 through conductors 67, 68 such that the first and second electrodes 61, 62 have positive and negative polarities, respectively. The first electrode 61 is in the form of a first active metal wire 411 extending through a central passage 201 in the wire guiding sleeve 20 and into the combustion chamber 210 and electrically insulated from the cylinder body 21. The first active metal wire 411 has an end portion 4115 disposed adjacent to the second electrode 62 in the combustion chamber 210 and operatively associated with the second electrode 62 to generate an arc therebetween when the power supplying source 5 applies a voltage to the first and second electrodes 61, 62, thereby resulting in vaporization of the end portion 4115 of the first active metal wire 411 and generation of heat by exothermal oxidation of the metal vapor thus formed, which, in turn, results in expansion of the gases formed in the combustion chamber 210 to drive movement of the piston 24 in the cylinder 2.

The first wire supplying unit 4 is configured to feed the first active metal wire 411 into the combustion chamber 210, and includes a wire storing reel 41 for winding of the first active metal wire 411 thereon, and a wire driving means 42 having a motor 421, a pair of driving rollers 422 configured to receive the first active metal wire 411 from the wire storing reel 41 and to clamp the first active metal wire 411 therebetween, and a pair of guiding rollers 423 for guiding movement of the first active metal wire 411 into the combustion chamber 210. The driving rollers 422 are driven by the motor 421 to rotate so as to feed the first active metal wire 411 into the combustion chamber 210. The motor 421 is preferably a step motor for controlling the feeding speed of the first active metal wire 411.

In this embodiment, the second electrode 62 is secured to the cylinder body 21 and is in the form of a conductive rod of a refractory material. The second electrode 62 extends into and through the channel 271 in the electrode-mounting sleeve 27. The protective gas supplying source 45 is connected to the electrode-mounting sleeve 27 so as to supply a protective gas into the channel 271 and to introduce the protective gas around the second electrode 62 to protect the second electrode 62 from oxidizing.

Preferably, the protective gas is selected from the group consisting of hydrogen, nitrogen, helium, neon, argon, krypton, xenon, radon, and combinations thereof.

Preferably, the refractory material for forming the second electrode 62 is selected from the group consisting of hafnium, hafnium alloys, niobium, niobium alloys, molybdenum, molybdenum alloys, osmium, osmium alloys, tantalum, tantalum alloys, rhenium, rhenium alloys, tungsten, tungsten alloys, graphite, and graphite composites.

Preferably, the first active metal wire 411 is made from a metallic material selected from the group consisting of aluminum, aluminum alloys, magnesium, magnesium alloys, calcium, calcium alloys, titanium, titanium alloys, zirconium, zirconium alloys, iron, iron alloys, chromium, and chromium alloys. More preferably, the first active metal wire 411 is aluminum.

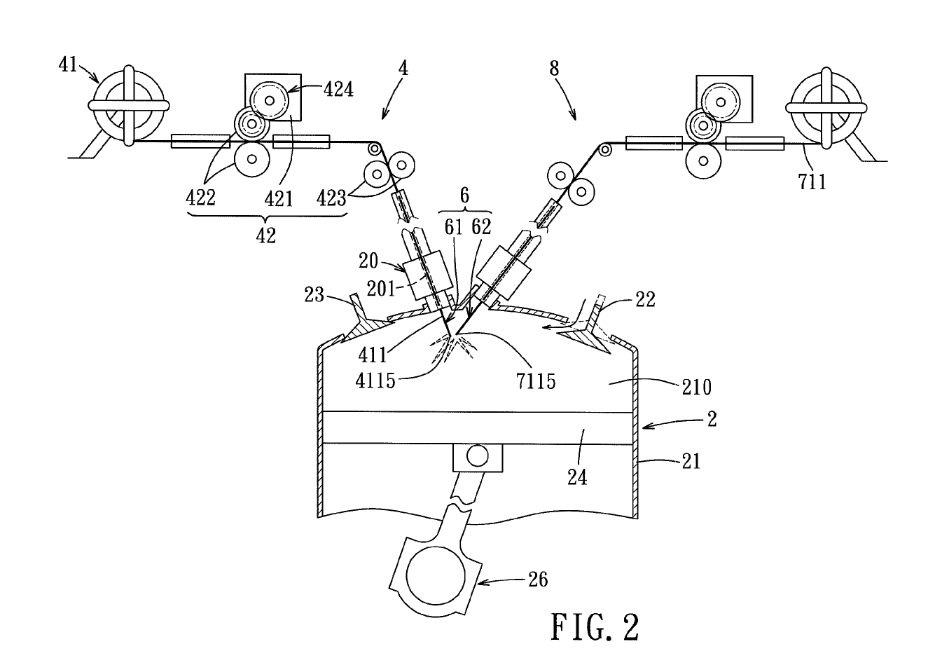

FIG. 2 illustrates the second preferred embodiment of the metal fuel powered driving system according to this invention. The second preferred embodiment differs from the previous embodiment in that the second electrode 62 is in the form of a second active metal wire 711 instead of the conductive rod and that a second wire supplying unit 8 is used to feed the second active metal wire 711 into the combustion chamber 210. The second wire supplying unit 8 has a structure the same as that of the first wire supplying unit 4.

In this embodiment, the second active metal wire 411 is made from a metallic material selected from the group consisting of aluminum, aluminum alloys, magnesium, magnesium alloys, calcium, calcium alloys, titanium, titanium alloys, zirconium, zirconium alloys, iron, iron alloys, chromium, and chromium alloys. More preferably, the second active metal wire 411 is aluminum. The second active metal wire 711 has an end portion 7115 disposed adjacent to the end portion 4115 of the first active metal wire 411 so as to generate an arc therebetween, thereby resulting in vaporization of the end portions 4115, 7115 of the first and second active metal wires 411, 711.

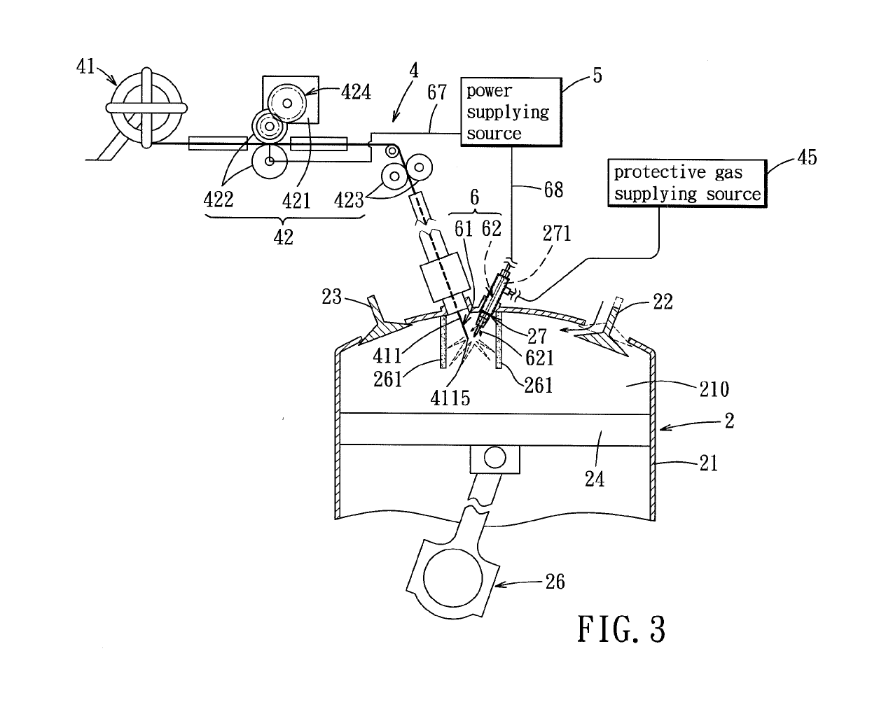

FIG. 3 illustrates the third preferred embodiment of the metal fuel powered driving system according to this invention. The third preferred embodiment differs from the first preferred embodiment in that the cylinder 2 further has two opposite confining walls 261 made from the refractory material and extending from an inner wall of the cylinder body 21 into the combustion chamber 210. The end portion 4115 of the first active metal wire 411 and an end portion 621 of the second electrode 62 are disposed between the confining walls 261. The confining walls 261 serve to block thermal radiation of the arc generated between the end portion 4115 of the first active metal wire 411 and the end portion 621 of the second electrode 62 and to confine the heat of the arc therein so as to enhance vaporization of the end portion of the first active metal wire 411 and exothermal oxidation of the metal vapor thus formed.

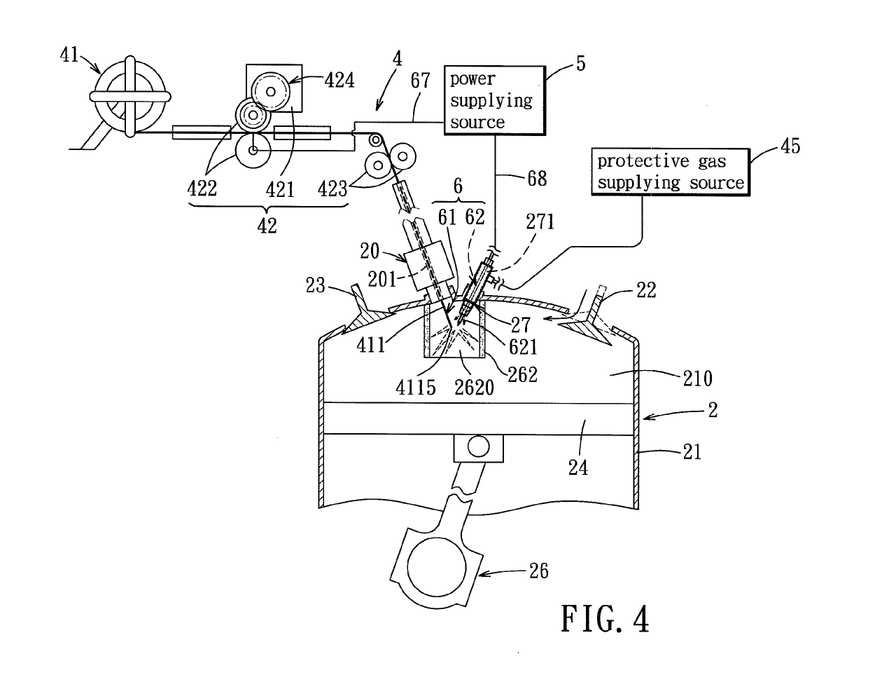

FIG. 4 illustrates the fourth preferred embodiment of the metal fuel powered driving system according to this invention. The fourth preferred embodiment differs from the first preferred embodiment in that the cylinder 2 further has a loop-shaped (such as tubular or polygonal in shape) confining wall 262 made from the refractory material and protruding inwardly from an inner wall of the cylinder body 21 into the combustion chamber 210. The confining wall 262 defines a confining space 2620 in fluid communication with the combustion chamber 210. The end portion 4115 of the first active metal wire 411 and the end portion 621 of the second electrode 62 are disposed in the confining space 2620. The confining wall 262 provides a similar function as that of the confining walls 261 in confining the heat of the arc.

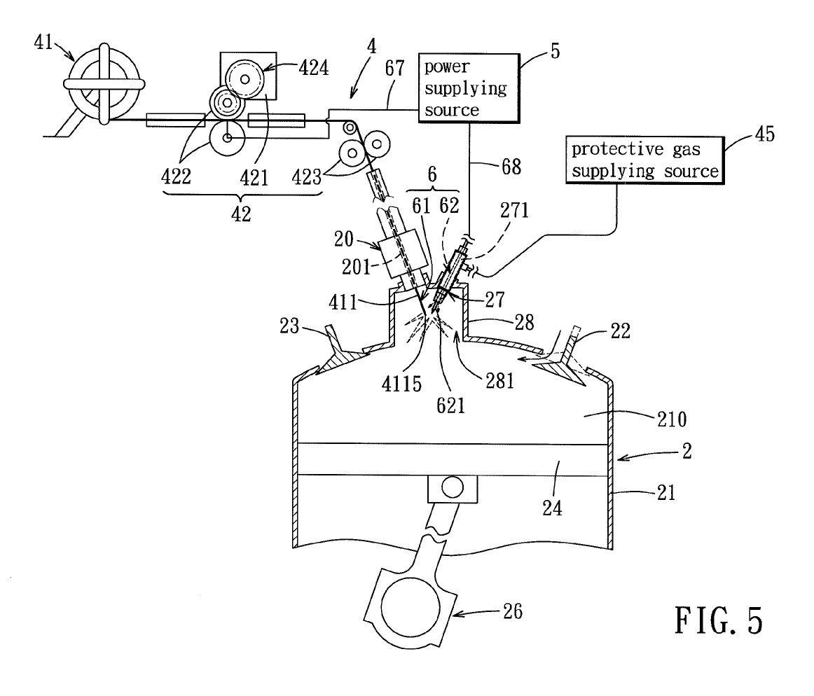

FIG. 5 illustrates the fifth preferred embodiment of the metal fuel powered driving system according to this invention. The fifth preferred embodiment differs from the first preferred embodiment in that the cylinder body 21 has a main wall portion and a tubular neck portion 28 reduced in cross-section from the main wall portion and defining a confining space 281 in fluid communication with the combustion chamber 210. The electrode-mounting sleeve 27 together with the second electrode 62 is mounted on and extends through a wall of the neck portion 28 into the confining space 281. The end portion 4115 of the first active metal wire 411 and the end portion 621 of the second electrode 62 are disposed in the confining space 281. The neck portion 28 provides a similar function as that of the confining walls 261 in confining the heat of the arc without occupying a space in the combustion chamber 210.

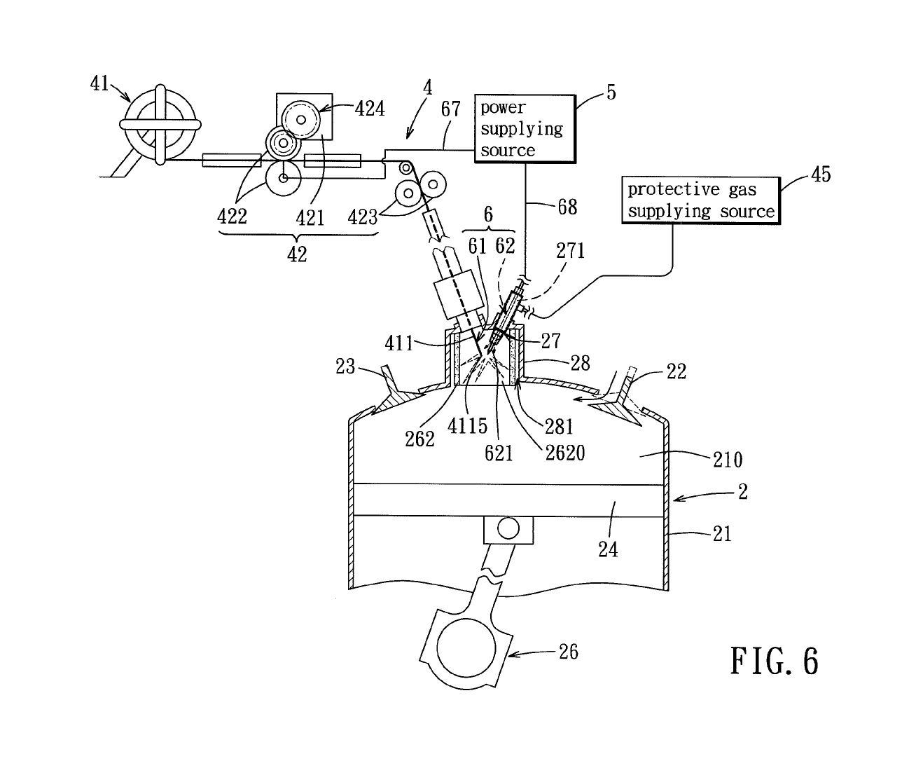

FIG. 6 illustrates the sixth preferred embodiment of the metal fuel powered driving system according to this invention. The sixth preferred embodiment differs from the fifth preferred embodiment in that the cylinder 2 further has a tubular inner confining wall 262 made from the refractory material, disposed inside the neck portion 28 of the cylinder body 21, and defining an inner confining space 2620. The end portion 4115 of the first active metal wire 411 and the end portion 621 of the second electrode 62 are disposed in the inner confining space 2620.

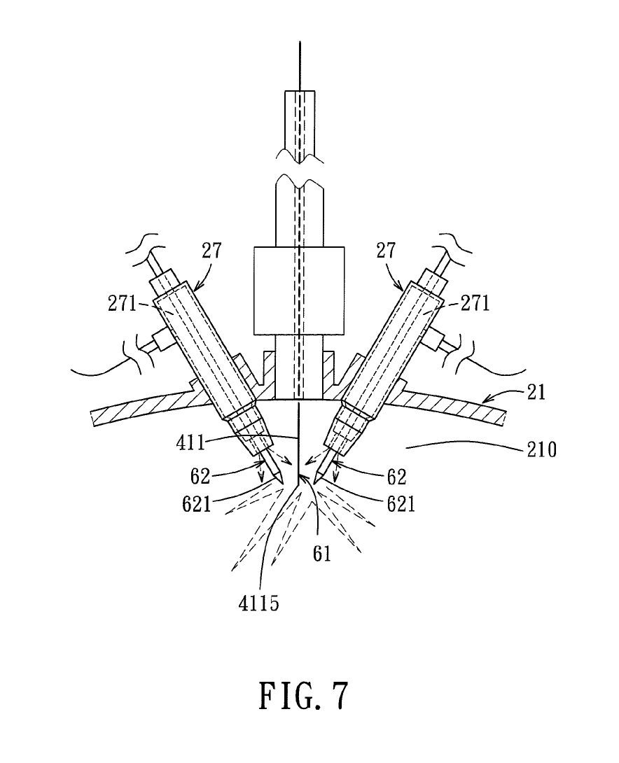

FIG. 7 illustrates the seventh preferred embodiment of the metal fuel powered driving system according to this invention. The seventh preferred embodiment differs from the first preferred embodiment in that the arc generating unit 6 further includes an additional electrode-mounting sleeve 27 mounted on the cylinder body 21 and an additional second electrode 62 extending through the additional electrode-mounting sleeve 27 into the combustion chamber 210. The end portions 621 of the second electrodes 62 are disposed at two opposite sides of the end portion 4115 of the first active metal wire 411, respectively. As such, vaporization of the end portion 4115 of the first active metal wire 411 can be enhanced.

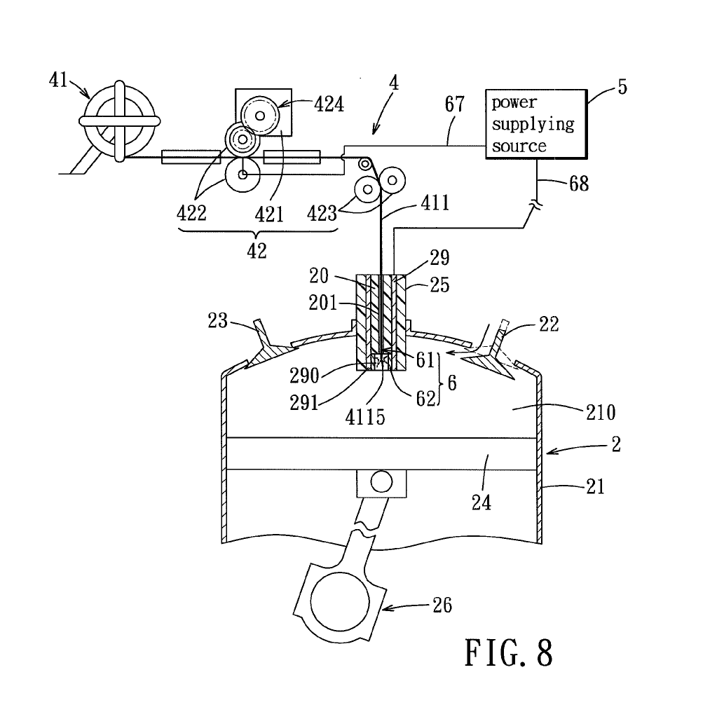

FIG. 8 illustrates the eighth preferred embodiment of the metal fuel powered driving system according to this invention. The eighth preferred embodiment differs from the first preferred embodiment in that the cylinder 2 further has a tubular mounting seat 25, a tubular conductor 29 mounted in the tubular mounting seat 25, connected electrically to the power supplying source 5 and having a lower end portion 291, and an insulative wire guiding sleeve 20 mounted in the tubular conductor 29. In this preferred embodiment, the tubular mounting seat 25 extends through the wall of the cylinder body 21 into the combustion chamber 210. The lower end portion 291 of the tubular conductor 29 defines an inner confining space 290. The first active metal wire 411 extends through a central passage 201 in the insulative wire guiding sleeve 20 and into the inner confining space 290 such that the end portion 4115 of the first active metal wire 411 is disposed in the inner confining space 290. The second electrode 62 is made from the refractory material, is disposed in the inner confining space 290 adjacent to the end portion 4115 of the first active metal wire 411, and contacts the lower end portion 291 of the tubular conductor 29.

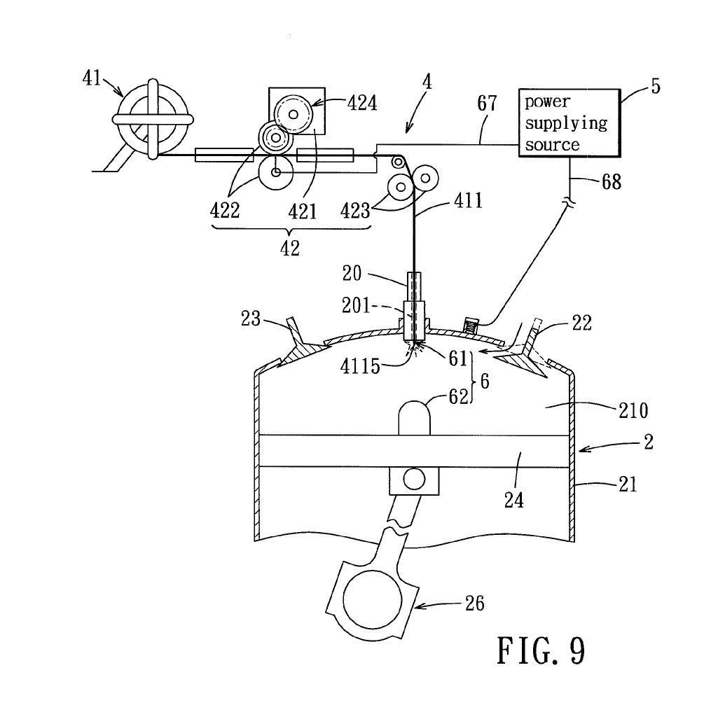

FIG. 9 illustrates the ninth preferred embodiment of the metal fuel powered driving system according to this invention. The ninth preferred embodiment differs from the first preferred embodiment in that the second electrode 62 is provided on the piston 24, protrudes therefrom into the combustion chamber 210, and is electrically connected to the power supplying source 5 through the piston 24 and the cylinder body 21 which are made from a conductive material and which are electrically connected to the power supplying source 5. Alternatively, the second electrode 62 can be electrically connected to the power supplying source 5 through a connecting means (not shown) which is connected to the power supplying source 5. As an example, the connecting means may include a conductive connector mounted on the cylinder body 21 and connected to the power supplying source 5, and a flexible conductive wire connected to the piston 24 and the conductive connector and having a length greater than a maximum moving distance of the piston 24. The piston 24 is operable to move the second electrode 62 toward and away from the end portion 4115 of the first active metal wire 411 so as to vary the distance between the end portion 4115 of the first active metal wire 411 and the second electrode 62. The smallest distance between the end portion 4115 of the first active metal wire 411 and the second electrode 62 is arranged to be sufficient for generating arc under an applied voltage to cause vaporization of the end portion 4115 of the first active metal wire 411 and exothermal oxidation of the metal vapor thus formed.

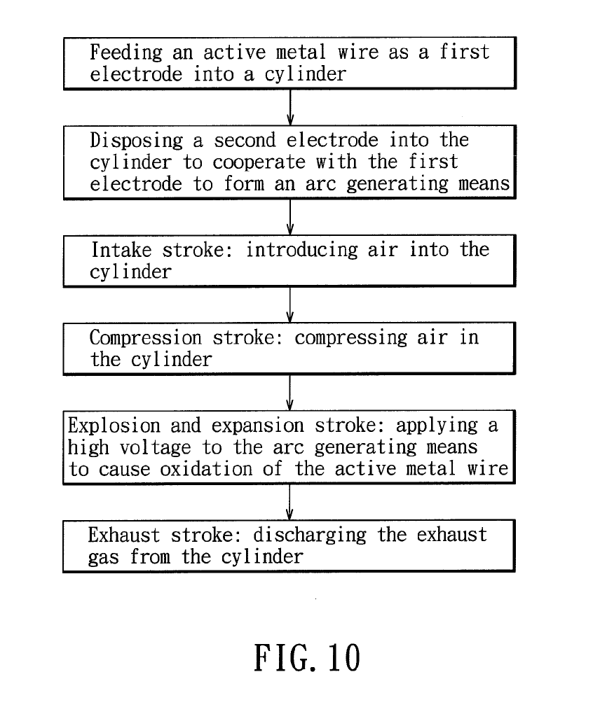

FIG. 10, in combination with any one of FIGS. 1 to 7, illustrates consecutive operating steps employed in a preferred embodiment of a method of driving a piston 24 in a cylinder 2 of a four-stroke engine. The method includes the steps of: supplying a first active metal wire 411 as a first electrode 61 into a combustion chamber 210 of the cylinder 2; providing a second electrode 62 that extends into the combustion chamber 210 such that an end portion 621 of the second electrode 62 is disposed adjacent to an end portion 4115 of the first active metal wire 411 in the combustion chamber 210; introducing air into the combustion chamber 210 through the intake valve 22 during an intake stroke; compressing the air in the combustion chamber 210 during a compression stroke; applying a voltage to the first and second electrodes 61, 62 to generate arc between the end portion 4115 of the first active metal wire 411 and the end portion 621 of the second electrode 62 so as to vaporize the end portion 4115 of the first active metal wire 411 and to effect exothermal oxidation of the metal vapor thus formed, thereby resulting in generation of thermal energy to drive movement of the piston 24 in the cylinder 2 (explosion and expansion stroke); and discharging the exhaust gases in the combustion chamber 210 through continuous movement of the piston 24 during an exhaust stroke. The four-stroke cycle including the intake stroke, the compression stroke, the explosion and expansion stroke and the exhaust stroke repeats itself when the exothermal oxidation of the active metal in the combustion chamber 210 continues. The discharged exhaust gases are allowed to pass through a filter (not shown) to filter the metal oxide powder formed by reaction of the active metal with oxygen so as to recycle the metal oxide thus formed.

Preferably, the method further includes pressurizing the air through an air compressor (not shown) before introducing it into the combustion chamber 210 for enhancing exothermal oxidation of the metal vapor thus formed.

Preferably, the method further includes adding ozone into the air through an ozone generator (not shown) and -/or adding water into the air to increase the moisture content in the air before introducing the air into the combustion chamber 210 for enhancing exothermal oxidation of the metal vapor thus formed.

Preferably, the method further includes introducing a protective gas around the second electrode 62 to protect the second electrode 62 from oxidizing.

The metal fuel powered driving system or the method of this invention has the advantages of readily incorporating the feeding mechanism of the active metal wire into a conventional engine, substituting the active metal (a clean fuel) for the hydrocarbon fuel to eliminate generation of carbon dioxide and air pollution, recycling of the metal oxide thus formed, and eliminating the use of complicated metal powder feeding means and metal powder heating means as required in the conventional power generating systems. The metal fuel powered driving system of this invention has the potential of being incorporated into a conventional electric-powered vehicle to form a hybrid metal fuel-and-electric powered vehicle or a conventional internal combustion engine to form a hybrid metal-and-gasoline fuel internal combustion engine or a bi-fuel internal combustion engine.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A metal fuel powered driving system, comprising:
a cylinder having a cylinder body and intake and exhaust valves provided on said cylinder body;
a piston disposed movably in said cylinder body and cooperating with said cylinder body to define a combustion chamber therebetween;
an arc generating unit including first and second electrodes extending into said combustion chamber, said first electrode being in the form of a first active metal wire; and
a first wire supplying unit configured to feed said first active metal wire into said combustion chamber;
wherein said first active metal wire has an end portion disposed adjacent to said second electrode in said combustion chamber and operatively associated with said second electrode to generate an electric arc therebetween when a voltage is applied to said first and second electrodes, thereby resulting in vaporization of said end portion of said first active metal wire and generation of heat by exothermal oxidation of the metal vapor thus formed.

2. The metal fuel powered driving system of claim 1, wherein said second electrode is secured to said cylinder body and is in the form of a conductive rod of a refractory material.

3. The metal fuel powered driving system of claim 2, wherein said refractory material is selected from the group consisting of hafnium, hafnium alloys, niobium, niobium alloys, molybdenum, molybdenum alloys, osmium, osmium alloys, tantalum, tantalum alloys, rhenium, rhenium alloys, tungsten, tungsten alloys, graphite, and graphite composites.

4. The metal fuel powered driving system of claim 1, further comprising a second wire supplying unit, said second electrode being in the form of a second active metal wire, said second wire supplying unit being configured to feed said second active metal wire into said combustion chamber.

5. The metal fuel powered driving system of claim 1, wherein said first active metal wire is made from a metallic material selected from the group consisting of aluminum, aluminum alloys, magnesium, magnesium alloys, calcium, calcium alloys, titanium, titanium alloys, zirconium, zirconium alloys, iron, iron alloys, chromium, and chromium alloys.

6. The metal fuel powered driving system of claim 4, wherein said second active metal wire is made from a metallic material selected from the group consisting of aluminum, aluminum alloys, magnesium, magnesium alloys, calcium, calcium alloys, titanium, titanium alloys, zirconium, zirconium alloys, iron, iron alloys, chromium, and chromium alloys.

7. The metal fuel powered driving system of claim 1, wherein said first wire supplying unit includes a wire storing reel for winding of said first active metal wire thereon, and a wire driving means having a motor and a pair of driving rollers configured to receive said first active metal wire from said wire storing reel and to clamp said first active metal wire therebetween, said driving rollers being driven by said motor to rotate so as to feed said first active metal wire into said combustion chamber.

8. The metal fuel powered driving system of claim 7, wherein said motor is a step motor.

9. The metal fuel powered driving system of claim 1, further comprising a protective gas supplying source, said cylinder further having an electrode-mounting sleeve provided on said cylinder body and extending through said cylinder body into said combustion chamber, said electrode-mounting sleeve defining a channel therein, said second electrode extending into and through said channel, said protective gas supplying source being connected to said electrode-mounting sleeve so as to supply a protective gas into said channel.

10. The metal fuel powered driving system of claim 9, wherein said protective gas is selected from the group consisting of hydrogen, nitrogen, helium, neon, argon, krypton, xenon, radon, and combinations thereof.

11. The metal fuel powered driving system of claim 1, wherein said cylinder further has two opposite confining walls made from a refractory material and extending from said cylinder body into said combustion chamber, said end portion of said first active metal wire and an end portion of said second electrode being disposed between said confining walls.

12. The metal fuel powered driving system of claim 1, wherein said cylinder further has a loop-shaped confining wall protruding therefrom and defining a confining space in fluid communication with said combustion chamber, said end portion of said first active metal wire and an end portion of said second electrode being disposed in said confining space.

13. The metal fuel powered driving system of claim 1, wherein said arc generating unit further includes an additional second electrode extending into said combustion chamber, each of said second electrodes being in the form of a conductive rod of a refractory material, said second electrodes having end portions disposed at two opposite sides of said end portion of said first active metal wire, respectively.

14. The metal fuel powered driving system of claim 1, wherein said cylinder further has a tubular mounting seat, a tubular conductor mounted in said tubular mounting seat, connected electrically to said power supplying source and having a lower end portion, and an insulative wire guiding sleeve mounted in said tubular conductor, said tubular mounting seat being provided on said cylinder body and extending through said cylinder body into said combustion chamber, said lower end portion of said tubular conductor defining an inner confining space, said first active metal wire extending through said insulative wire guiding sleeve and into said inner confining space, said second electrode being disposed in said inner confining space and being provided on said lower end portion of said tubular conductor.

15. The metal fuel powered driving system of claim 1, wherein said second electrode is provided on said piston, protrudes therefrom into said combustion chamber, and is electrically connected to said power supplying source.

16. A method of driving a piston in a cylinder, said method comprising:
supplying a first active metal wire as a first electrode into a combustion chamber of the cylinder;
providing a second electrode that extends into the combustion chamber;
introducing air into the combustion chamber; and
applying a voltage to the first and second electrodes to generate an arc between an end portion of the first active metal wire and the second electrode so as to vaporize the end portion of the first active metal wire and to start exothermal oxidation of the metal vapor thus formed, thereby resulting in generation of thermal energy to drive movement of the piston in the cylinder.

17. The method of claim 16, wherein the second electrode is secured to the cylinder body and is in the form of a conductive rod of a refractory material.

18. The method of claim 17, wherein the refractory material is selected from the group consisting of hafnium, hafnium alloys, niobium, niobium alloys, molybdenum, molybdenum alloys, osmium, osmium alloys, tantalum, tantalum alloys, rhenium, rhenium alloys, tungsten, tungsten alloys, graphite, and graphite composites.

19. The method of claim 16, wherein the second electrode is in the form of a second active metal wire that is feed into the combustion chamber.

20. The method of claim 16, wherein the first active metal wire is made from a metallic material selected from the group consisting of aluminum, aluminum alloys, magnesium, magnesium alloys, calcium, calcium alloys, titanium, titanium alloys, zirconium, zirconium alloys, iron, iron alloys, chromium, and chromium alloys.

21. The method of claim 16, wherein the first active metal wire is aluminum.

22. The method of claim 19, wherein the second active metal wire is made from a metallic material selected from the group consisting of aluminum, aluminum alloys, magnesium, magnesium alloys, calcium, calcium alloys, titanium, titanium alloys, zirconium, zirconium alloys, iron, iron alloys, chromium, and chromium alloys.

23. The method of claim 22, wherein the first active metal wire is aluminum.

24. The method of claim 16, further comprising pressurizing the air before introducing it into the combustion chamber for enhancing exothermal oxidation of the metal vapor thus formed.

25. The method of claim 16, further comprising adding ozone into the air before introducing the air into the combustion chamber for enhancing exothermal oxidation of the metal vapor thus formed.

26. The method of claim 16, further comprising adding water into the air to increase the moisture content in the air before introducing the air into the combustion chamber for enhancing exothermal oxidation of the metal vapor thus formed.

27. The method of claim 16, further comprising adding water into the air to increase the moisture content in the air and adding ozone into the air before introducing the air into the combustion chamber for enhancing exothermal oxidation of the metal vapor thus formed.

28. The method of claim 16, further comprising introducing a protective gas around the second electrode to protect the second electrode from oxidizing.

29. The method of claim 28, wherein the protective gas is selected from the group consisting of hydrogen, nitrogen, helium, neon, argon, krypton, xenon, radon, and combinations thereof.

30. The method of claim 16, further comprising discharging the exhaust gas from the combustion chamber and filtering the exhaust gas to collect a metal oxide powder formed by exothermal oxidation of the metal vapor.
